(19) United States
(12) Patent Application Publication
(10) Pub. No.: US 2026/0167415 A1
(43) Pub. Date: Jun. 18, 2026

(54) Leaf Compactor Article

(71) Applicant: Fouad Boueri, San Antonio, TX (US)

(72) Inventor: Fouad Boueri, San Antonio, TX (US)

(21) Appl. No.: 18/978,905

(22) Filed: Dec. 12, 2024

(51) Int. Cl. B65F 1/14

(52) U.S. Cl. CPC B65F 1/1405; B65F 2240/138

(57) ABSTRACT

Within the field of household and or gardening and or landscaping and or cleaning tools, there is an absence of articles that effectively eliminate the need for bending during the manual process of compacting dead leaves being bagged. The leaf compactor invention herein allows a rake or broom or tool to which it is attached (or being part of) to achieve this purpose.

### PURPOSE

To provide a lead compactor (and or functionality) that is attachable to (or part of) rakes or other tools.

### FIELD

Household and or gardening and or landscaping and or cleaning tools.

### CONTEXT

The manual process of cleaning dead leaves usually consists of raking the leaves, then bagging them in a container. The bagging process usually involves several instances of bending in order to compact the leaves inside the container with the purpose of making room for more leaves in the same container. This repeated motion leads to fatigue and back pain.

### ADVANTAGES OF THE INVENTION

The leaf compactor (as part of or possible attachment to a rake or broom or tool) would eliminate the need for bending to compact the leaves and or to use a separate tool to compact the leaves. It can be attached to (or be part of) the handle of a rake or broom or tool. After raking and bagging leaves, the rake or broom or tool (with the attached leaf compactor at the upper end of it) can be turned upside down and used as a leaf compactor (which would become at the bottom end of the tool once turned upside down).

### DRAWING FIGURES

Please see separate second file.

### BRIEF DESCRIPTION OF THE DRAWINGS

FIG. 1: sketch of the leaf compactor article.

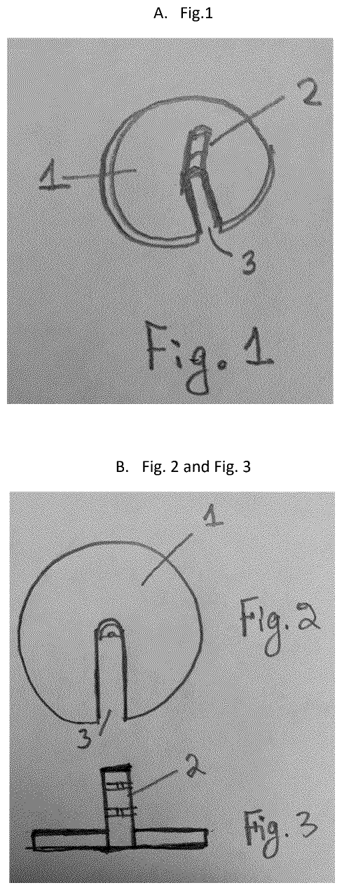

FIG. 2: top view of the leaf compactor article.

FIG. 3: side view of the leaf compactor article.

Annotations in FIG. 1, FIG. 2, FIG. 3:
1) Surface of rigid material that compacts leaves when pushed down towards the bottom of a barrel or container.
2) Means of attachment.
3) Empty space to insert handle of raking tool in order to attach leaf compactor to handle.

FIG. 4: rendering and photo of the leaf compactor article.

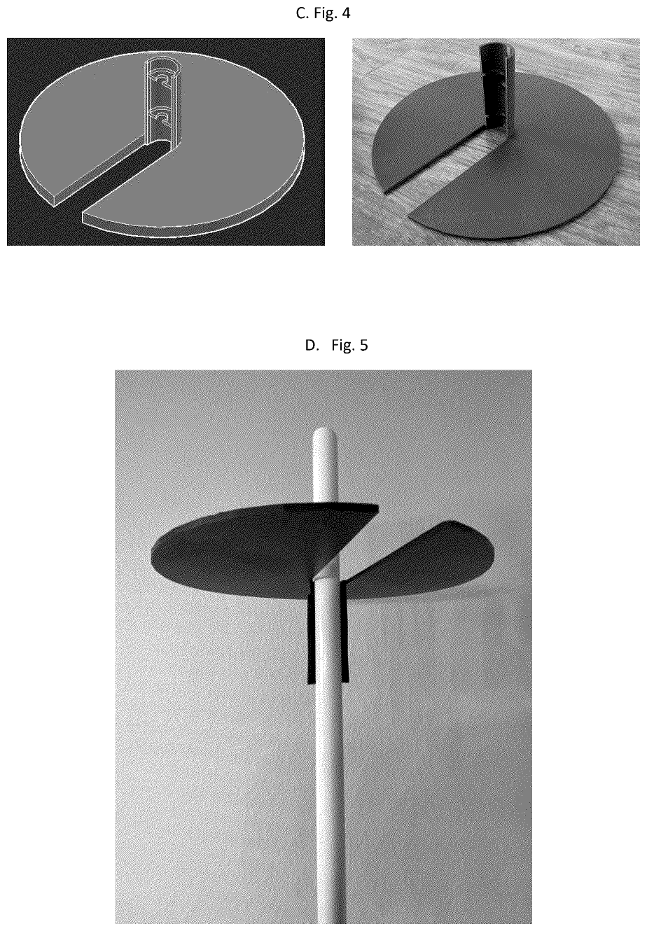

FIG. 5: photo of the leaf compactor article when attached to the handle of a tool.

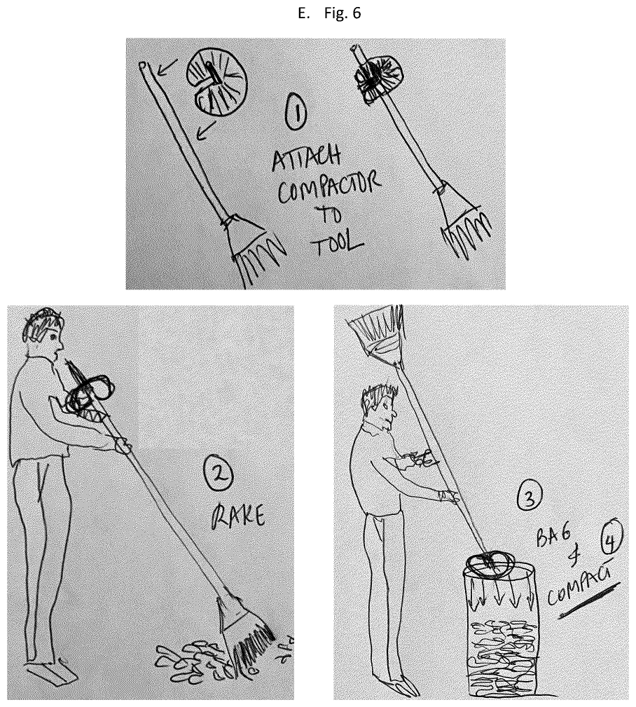

FIG. 6: sketch illustrating how to use the leaf compactor article within the 4 steps typically constituting the manual process of cleaning fallen leaves:
1) Attach the leaf compactor article to the handle of a raking tool.
2) Rake the leaves on the ground.
3) Bag the leaves in a container.
4) Turn the tool upside down in order to compact the leaves in the container with the purpose of making room for more leaves in the same container, without having to bend.

### DESCRIPTION

The leaf compactor has a disc-like shape with a narrow opening that leads from the outer periphery to a protruding piece at the center. This makes it easily attachable to a rake or broom stick or handle. The leaf compactor can alternatively be part of the tool.

### RAMIFICATIONS

The diameter and shape of the leaf compactor can have alternate dimensions and variants, with the purpose of fitting bins with other shapes and sizes.

The size of the interlock mechanism can have alternate dimensions, with the purpose of fitting tool handles with other thicknesses and diameters.

The material of the leaf compactor can have alternate versions depending on the robustness requirement.

1. Claim

What is claimed is:

1. Leaf compactor article capable of attaching to, or being part of another tool's handle. Said article comprising
a. a surface of rigid material having sufficient area to compact leaves in a leaves container, and
b. an attachment means for addition of said article to another tool handle.
